(19) United States
(12) Patent Application Publication
(10) Pub. No.: US 2021/0325277 A1
(43) Pub. Date: Oct. 21, 2021

(54) METHOD FOR PREDICTING THE REMAINING SERVICE LIFE OF A MACHINE

(71) Applicant: Aktiebolaget SKF, Göteborg (SE)

(72) Inventors: Kareem Gouda, Gothenburg (SE); Haiyang (Jackson) Li, Gothenburg (SE)

(21) Appl. No.: 17/207,684

(22) Filed: Mar. 21, 2021

(30) Foreign Application Priority Data
Apr. 15, 2020 (CN) 202010294399.4

(51) Int. Cl. G01M 13/045; G05B 23/02

(52) U.S. Cl. CPC G01M 13/045; F16C 2233/00; G05B 23/0283; G05B 23/0254

(57) ABSTRACT

A method for predicting a remaining useful life of a machine on the basis of a data record, according to the following steps. Step 1) using regression analysis to fit a mathematical model of a machine life curve reflecting a variable relationship between time and a characteristic value, and calculating the time needed for the life curve to reach a preset failure threshold, and step 2) repeating step 1 above with a portion of data randomly omitted, and obtaining statistically a probability distribution of the expected RUL according to a repetition result. The RUL corresponding to the maximum probability distribution is determined to be the most likely expected RUL of the machine. The above method avoids bias in the prediction of machine RUL using a single life curve model, and can significantly improve the reliability and accuracy of machine prediction.

### CROSS-REFERENCE TO RELATED APPLICATIONS

This application claims priority to Chinese Patent Application no. 202010294399.4, filed Apr. 15, 2020, the contents of which is fully incorporated herein by reference.

### TECHNICAL FIELD

The present invention relates to a method for predicting a remaining useful life (abbreviated as “RUL”) of a machine and/or component (hereinafter collectively referred to as “machines”), in particular a method for predicting an RUL of a machine on the basis of probability statistics.

### BACKGROUND ART

Regression analysis is a commonly used method for determining a quantitative relationship between associated variables (based on a mathematical model), and is widely applied in methods for predicting the RUL of machines. In an existing method, regression analysis is only used to obtain a best fit curve for machine life, but a prediction result based on a single best fit solution is often biased, and therefore can hardly be used as a reliable basis for initiating maintenance measures. In practice, people still have to face unknown machine faults and the resulting shutdown losses. Reality calls for a machine life prediction method capable of meeting the need for reliable prediction in modern production.

### SUMMARY OF THE INVENTION

To solve the abovementioned technical problem, the present invention provides a method for predicting a remaining useful life (RUL) of a machine on the basis of a (time)-(characteristic value) historical data record, comprising: step 1) using regression analysis to fit a mathematical model of a machine life curve reflecting a variable relationship between time and a characteristic value, and calculating the time needed for the machine life curve to reach a preset failure threshold, i.e. an expected RUL, according to the model; and step 2) repeating step 1 with a portion of data randomly rejected, and obtaining statistically a probability distribution of the expected RUL according to a repetition result, wherein the expected RUL corresponding to the maximum probability distribution is determined to be the most likely expected RUL of the machine.

The above method avoids bias in the prediction of machine RUL using a single life curve model, and can significantly improve the reliability and accuracy of prediction.

### BRIEF DESCRIPTION OF THE DRAWINGS

FIG. 1 shows a schematic diagram of a function model of a machine in a stable operating state.

FIG. 2 shows a schematic diagram of a function model of the machine in a linear failure operating state.

FIG. 3a shows a schematic diagram of a quadratic polynomial function model of the machine in an accelerated failure operating state.

FIG. 3b shows a schematic diagram of an exponential function model of the machine in an accelerated failure operating state.

FIG. 4 shows a schematic diagram of a method for determining the best state turning point combination, based on the principle of minimum cumulative loss function.

FIG. 5 shows a schematic diagram of a life curve bundle, fitted by randomly rejecting a portion of data, reaching a failure threshold.

FIG. 6 shows a probability distribution diagram of the time needed for the life curve bundle shown in FIG. 5 to reach the failure threshold (i.e. the expected RUL).

### DETAILED DESCRIPTION OF THE INVENTION

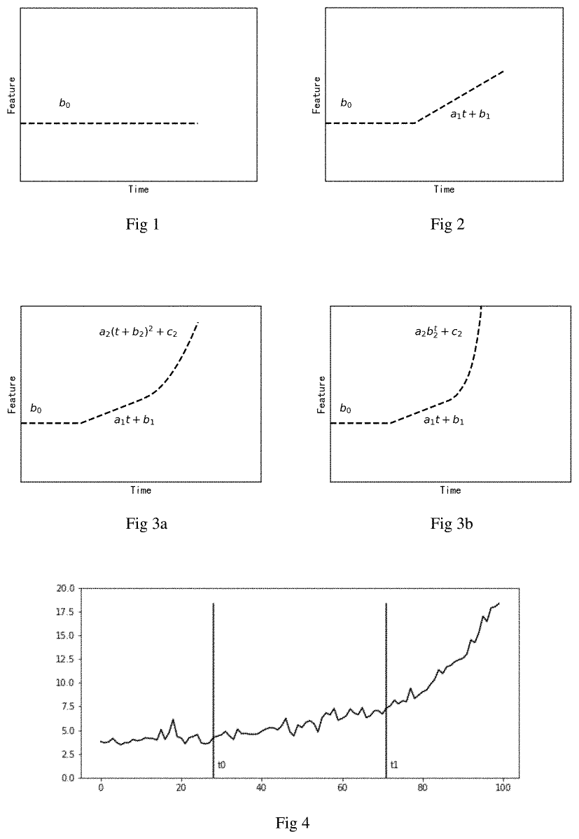

FIGS. 1-3 show the entire process of a typical life cycle of a machine, developing from a stable operating state to an accelerated failure state. FIG. 1 shows the machine in a state of stable operation (state 1), wherein a relevant performance index is substantially constant, and a mathematical model is represented by a functional relation ƒ(t)=b₀(t≥0) (formula \textcircled{1}); FIG. 2 shows the device in an early damage stage, wherein a relevant performance index is in a state of linear deterioration (state 2), and a mathematical model is represented by a functional relation ƒ(t)=a₁t+b₁(a₁>0) (formula \textcircled{2}); FIGS. 3a and 3b show the device in a severe damage stage, wherein a relevant performance index is in a state of accelerated deterioration (state 3), and a typical mathematical model is represented by a quadratic polynomial function ƒ(t)=a₂(t+b₂)²+c₂(a₂>0, b₂<0) (formula \textcircled{3}) or an exponential function ƒ(t)=a₂b₂^{t}+c₂(a₂>0, b₂>1) (formula \textcircled{4}).

The relevant performance index is described by a characteristic value in the present invention. The term “characteristic value” is an open concept, which in theory includes any information index capable of being used to characterize the properties of a machine in terms of performance, quality and state, etc., and can be quantified as any measurement unit capable of being acquired through human perception or technology. It may be a vibration characteristic (e.g. noise) or a non-vibration characteristic (e.g. degree of ageing of grease); it may be a fault characteristic or a non-fault characteristic; and it may be a beneficial characteristic or a detrimental characteristic. Taking a vibration characteristic as an example, in the case of a rotary machine (including components), such as an electric machine, rotor, rotation shaft, gear, bearing or bearing block, etc., the mechanical performance, quality defects and fault evolution thereof are often all contained in a vibration signal outputted thereby.

Thus, characteristic values based on vibration signals include signal data of speed, acceleration, energy and frequency, etc. in the time domain or frequency domain, and may also be derived data formed alone or in combination on the basis of these data, including but not limited to function values, statistical values and comparison values, etc. In FIGS. 1-5, the vertical coordinates are all characteristic values characterizing a performance index (or indices) of the machine.

Typically, the entire life cycle of the machine will develop from state 1 to state 2, and then further develop to state 3; during this time, state turning points t₀ and t₁(t₁≥t₀) are passed through sequentially. This is generally a progressive process, but there are exceptions. In some situations, a device will skip a particular state, and enter the next state directly. For example, it may enter state 3 directly from state 1, or directly enter state 2 or state 3 from the start. There are many reasons for machine state deterioration, including intra-system factors such as component failure or design defects, and extra-system factors such as intrusion by foreign bodies or improper installation, etc.

As stated above, the mathematical model of the machine life curve may use regression analysis for fitting; this is a prerequisite for predicting the RUL of the machine. However, the determination of turning points (positions) between adjacent states is challenging in currently known regression analysis methods.

Thus, the method used in the present invention is to at least partially traverse all possible turning point combinations, and obtain the best fit solution for the machine life curve by comparing cumulative loss function values of the life curve for each of the combinations. It is pointed out in passing that loss functions are functions for evaluating the degree of discreteness between a predicted value and a real value, and are commonly used in regression analysis to determine the best regression model by means of a minimum value. Commonly used loss functions include the mean squared error (MSE) function, etc., and are not discussed further here.

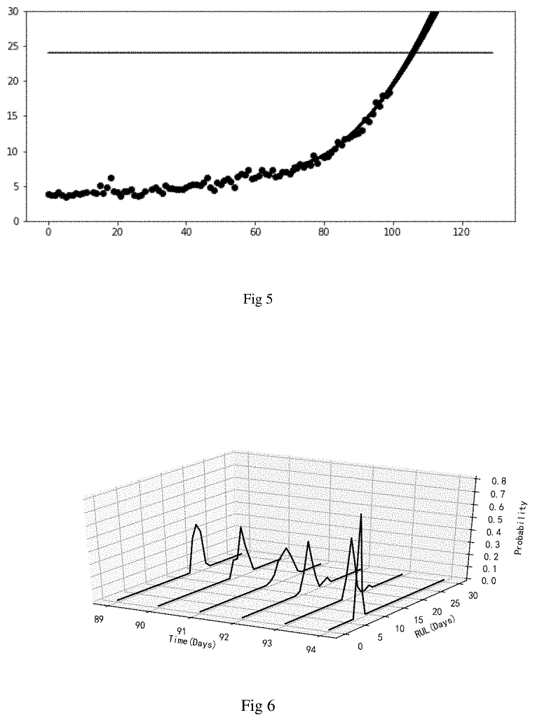

FIG. 4 shows a schematic diagram of a method for determining the best state turning point combination, based on the principle of minimum cumulative loss function. Firstly, suppose that state turning points t₀ and t₁ both correspond to a first data point in a (time)-(characteristic value) data record; then the life curve that is fitted on this basis should only include state 3. In this case, formula \textcircled{3} or \textcircled{4} may be used for fitting. Of course, after fitting, the result must be checked. Taking formula \textcircled{4} as an example, it is necessary to determine whether the fitting result satisfies the conditions a₂>0 and b₂>1.

If the conditions are not satisfied, then this fitting is discarded; if the conditions are satisfied, then the mean squared error (loss function) for the fitted curve and the data is calculated, and the best fit curve model for state 3 is sought by comparing the sizes of the loss function (formula \textcircled{4}). Here, the curve model for state 3 corresponding to the minimum mean squared error is taken to be the best fit solution.

Next, suppose that t₀ corresponds to a first data point, and t₁ corresponds to a second data point; in the case of such a turning point combination, the life curve of the machine should only include state 2 and state 3. Similarly to the fitting for state 3 above, the best fit curve for state 2 (formula \textcircled{2}) and the best fit curve for state 3 (formula \textcircled{3} or \textcircled{4}) are obtained by comparison, again based on the principle of minimum mean squared error.

A mean squared error cumulative value of the state 2 best fit curve and the state 3 best fit curve for the current turning point combination is then recorded, for the purposes of subsequent comparison.

Next, suppose that t₀ corresponds to a first data point, and t₁ corresponds to a third data point; in the case of such a turning point combination, the life curve of the machine should still only include state 2 and state 3. The above fitting process for state 2 and state 3 is repeated, until t₁ has traversed all data points after t₀ (or all designated data points).

For t₀ at a specific position, once t₁ has traversed all (designated) data points after t₀, t₀ should be moved from the current data point to the next (designated) data point, until t₀ also reaches the final (designated) data point. In this way, the present invention traverses all possible (or designated) turning point combinations, thereby obtaining the life curve of the machine for each combination. The designated turning point combinations may be turning point combinations distributed within a specific interval range, or turning point combinations selected according to a given rule.

As stated above, the fitted life curve of the machine for each turning point combination will form a mean squared error cumulative value, formed by summing the mean squared errors of the best fit curves of all states (states 1-3) contained therein. The present invention uses the mean squared error cumulative value as a judgement criterion, and through comparison, determines the turning point combination corresponding to the minimum mean squared error cumulative value to be the best turning point combination, wherein the best fit curves of all states (states 1-3) contained in the best turning point combination form the best fit solution for the machine life curve.

In other words, the present invention traverses all possible or designated turning point combinations, and taking the minimum loss function cumulative value for each of the combinations as the judgement criterion, obtains the machine life curve that is best adapted overall by comparing the loss function cumulative values.

The life cycle of a rotary machine generally always includes a full process of evolution from stable operation to gradual failure, and using a piecewise function to describe the life curve thereof is an effective method. The present invention is based on the principle of minimum loss function cumulative value, and screens out the optimal fitting solution by comparing the loss function cumulative values of the life curves corresponding to all turning point combinations. The method is suitable for fitting all machine life curves with a piecewise function as a model (regardless of the number of states and turning points contained therein), and is therefore of important practical value in the challenging problem of determining state turning points.

After determining a function model of the machine life curve, it is possible to calculate the time needed for the corresponding life curve to reach a predetermined failure threshold, i.e. a predicted RUL of the machine, according to the model. Specifically, when the life curve only satisfies formula \textcircled{1}, the machine is regarded as being in a stable operating stage, not yet having suffered damage, in which case the RUL is difficult to predict; when the life curve satisfies formula \textcircled{2}, the machine is regarded as being in an early stage of damage, and the RUL depends on the time point of intersection of formula \textcircled{2} and the failure threshold; when the life curve satisfies formula \textcircled{3} or \textcircled{4}, the device is in a severely damaged state, and the RUL depends on the predicted intersection point of formula \textcircled{3} or \textcircled{4} and the failure threshold.

However, as stated above, the method described above is established on the basis of a single life curve (although the fitting solution corresponds to the best turning point combination), and the RUL thereby obtained might be biased. Mathematically speaking, the RUL is the time needed for the life curve to reach the failure threshold, and is a subsequent derived value of a fitting result (life curve), thus the accuracy and reliability thereof are hardly convincing, and can hardly be used as a reliable basis for initiating maintenance measures in practice.

FIG. 5 shows a schematic diagram of the convergence, with a failure threshold, of a life curve bundle fitted after randomly rejecting a portion of data. In order to avoid the biased nature of a single fitting result, the present invention randomly rejects a portion of data, and fits different life curves according to a remaining data record. The curve bundle formed by life curves fitted on the basis of different data covers most possibilities in a statistical sense, and the RUL thereby obtained has a probability distribution in a statistical sense (e.g. normal distribution), wherein the possibility implied by the RUL corresponding to the maximum probability distribution is largest, and can serve as a reliable basis for predicting the RUL.

However, the amount of rejected data will have a significant effect on the trend of the fitted curve. If too much data is rejected, then data might be distorted and not conform to the real situation; if too little data is rejected, then this will not have a significant effect on the fitting result, and it will not be possible to obtain a curve bundle with a broad distribution in a statistical sense. It has been found through comparison that the data rejection ratio (i.e. percentage of the total data amount) should not exceed 50%, is preferably 20±10%, and further preferably 15±5%. As the data rejection ratio gradually converges, the fitted curve bundle also tends to become more concentrated, and a region of convergence with the failure threshold becomes gradually narrower. As shown in FIG. 5, this region determines the RUL range distribution; too wide a range makes it difficult to make an accurate prediction, but too narrow a range easily results in bias.

FIG. 6 shows a probability distribution diagram of the time needed for the failure threshold to be reached (i.e. the RUL) by a life curve bundle fitted by randomly rejecting a portion of data. The figure shows that as time elapses, the expected RUL becomes shorter and shorter. For example, on the 89^{th} day of machine operation, the expected RUL is 17-22 days; on the 94^{th} day of machine operation, the expected RUL is 7-10 days. On this basis, it is possible to formulate a maintenance plan in an early stage of a fault, and carry out adjustment at any time according to subsequent information updates.

It can also be seen from the figure that as time elapses, the probability distribution of the expected RUL also exhibits a trend of convergence. For example, on the 91^{st} day of machine operation, the remaining life corresponding to the maximum probability distribution (about 25%) is 21-22 days; on the 94^{th} day of machine operation, the RUL corresponding to the maximum probability distribution (about 50%) is 8 days. As the machine life approaches its end, the probability distribution of the RUL also tends to become more concentrated, and the reliability of prediction gradually improves; an information advance warning triggered on this basis can serve as a reliable basis for initiating maintenance, ensuring that the device undergoes prompt maintenance before a fault occurs.

In the method described above, there are also some specific features that can be changed or perfected. For example, if the state turning point t₀ and/or t₁ occurs in an end portion of the life curve, this might result in the subsequent state being biased due to an insufficient amount of data, and the RUL obtained on this basis is not very reliable. Thus, a time range can be set, e.g. located in the final 30%, 50 hours or 50 days of the life curve, and if t₀ or t₁ occurs in this time range, then the subsequent state is not subjected to fitting, or the fitted state model cannot serve as a model basis for predicting the RUL.

Furthermore, data from the time of shutdown does not reflect the real state of the machine, and should be rejected. In the present invention, if the characteristic value is less than 20% of an average value, then the machine is considered to be in a state of shutdown. Here, a relative threshold is used to filter data because the characteristic value ranges of different devices in a state of operation are different, and filtering based on a relative value can effectively reduce erroneous judgements.

The method for predicting device life as described above is suitable for all types of machine devices, and is particularly suitable for rotary machines (including components), e.g. electric machines, rotors, bearings and gears, etc. Those skilled in the art should understand that the method of the present invention is not limited by particular embodiments. Any changes and improvements to the present invention that are in conformity with the definitions in the attached claims are included in the scope of protection of the present invention.

1. A method for predicting a remaining useful life (RUL) of a machine on the basis of a data record, comprising the following steps:
step 1, using regression analysis to fit a mathematical model of a machine life curve reflecting a variable relationship between time and a characteristic value, and calculating the time needed for the life curve to reach a preset failure threshold, that is, an expected RUL, according to the model; and
step 2, repeating the step 1 with a portion of data randomly omitted, and obtaining statistically a probability distribution of the expected RUL according to a repetition result, wherein the RUL corresponding to the maximum probability distribution is determined to be the most likely expected RUL of the machine.

2. The method according to claim 1, wherein the omitted data accounts for no more than 50% of the total amount of data.

3. The method according to claim 2, wherein the omitted data accounts for 20±10% of the total amount of data.

4. The method according to claim 3, wherein the omitted data accounts for 15±5% of the total amount of data.

5. The method according to claim 1, wherein the mathematical model of the life curve is a function model comprising at least three operating states, specifically stable operation, linear failure and accelerated failure, wherein a data point between adjacent states is defined as a state turning point, and a best fit solution for the machine life curve is sought by comparing cumulative loss function values of life curves corresponding to all possible or designated turning point combinations.

6. The method according to claim 5, wherein the function model of the accelerated failure state is a quadratic polynomial function.

7. The method according to claim 5, wherein if the state turning point occurs within a certain time range in an end portion of the life curve, then a subsequent state is not fitted, or a subsequently fitted state function model cannot be used to predict the RUL of the machine.

8. The method according to claim 6, wherein the certain time range in the end portion of the life curve does not exceed 30% of a data record time range.

9. The method according to claim 1, wherein a relative threshold is used to filter out shutdown data.

10. The method according to claim 1, wherein the machine is a rotary machine, a bearing, or a combination thereof, and the characteristic value is a characteristic value based on a vibration signal.
